(19) United States
(12) Patent Application Publication
(10) Pub. No.: US 2012/0119449 A1
(43) Pub. Date: May 17, 2012

(54) Transition Piece Sealing Assembly With Seal Overlay

(75) Inventors: Mehmet Demiroglu, Schenectady, NY (US); Neelesh Nandkumar Sarawate, Niskayuna, NY (US); Edip Sevincer, Watervliet, NY (US); Benjamin Lacy, Greer, SC (US)

(73) Assignee: GENERAL ELECTRIC COMPANY, Schnectady, NY (US)

(21) Appl. No.: 12/943,978

(22) Filed: Nov. 11, 2010

(51) Int. Cl. F16J 15/02

(52) U.S. Cl. 277/652

(57) ABSTRACT

The present application provides a sealing assembly for use with a transition piece and a stage one nozzle of a gas turbine engine. The sealing assembly may include a seal element, an overlay piece positioned on the seal element, and a side seal positioned on the overlay piece.

### FEDERAL RESEARCH STATEMENT

This invention was made with Government support under Contract No. DE-FC26-05NT42643, awarded by the US Department of Energy (DOE). The Government has certain rights in this invention.

### TECHNICAL FIELD

The present application relates generally to gas turbine engines and more particularly relates to improved sealing assemblies for use between a transition piece and a stage one turbine nozzle and similar elements so as to provide high pressure air leakage therethrough.

### BACKGROUND OF THE INVENTION

Generally described, gas turbine engines may have a sealing assembly positioned between a transition piece(s) and a stage one nozzle and the like. The sealing assembly should prevent high pressure air from leaking into the hot airflow. The sealing assembly may accommodate the relative movement between the transition piece and the stage one nozzle due to, for example, dynamic pulsing, and the like. The transition piece and the first stage nozzle and/or the nozzle support elements thus may move radially, circumferentially, and/or axially relative to one another. Moreover, the transition piece and the first stage nozzle may be formed from different materials and subjected to different temperatures during operation. As a result, the transition piece and the stage one nozzle may experience different degrees of thermal growth.

This “mismatch” at the interface of the transition piece and the first stage nozzle and/or the nozzle support elements thus requires an effective sealing assembly to contain the combustion products and the pressure differential across the interface. Further, the sealing assembly also should prevent compressor discharge air from bypassing the combustor.

Known sealing assemblies may have a number of components including outer seal, an inner seal, and a pair of side seals. A gap may be formed where the inner and outer seals interface with the side seals. This gap may be a source of leakage therethrough. Specifically, if the side seals do not sit properly on the inner and outer seals, the gap may be created through which the leakage air may flow. Such leakage air rates may cause the gas turbine engine as a whole to fail to meet governmental nitrogen oxide (NOₓ) emissions requirements and/or other types of emissions regulations. Moreover, such leakage air rates may have an average impact on overall system efficiency.

There is thus a desire for an improved sealing assembly for use with a transition piece and a stage one nozzle and the like of a gas turbine engine. Such a sealing assembly preferably may seal effectively the gap between the inner and/or the outer nozzles and the side seals. Sealing the gap may result in improved emissions and overall system efficiency. The improvements herein preferably will be inexpensive but durable.

### SUMMARY OF THE INVENTION

The present application thus provides a sealing assembly for use with a transition piece and a stage one nozzle of a gas turbine engine. The sealing assembly may include a seal element, an overlay piece positioned on the seal element, and a side seal positioned on the overlay piece.

The present application further provides for a sealing assembly for use with a transition piece and a stage one nozzle of a gas turbine engine. The sealing assembly may include a first seal element with a first overlay piece positioned therein, a second seal element with a second overlay piece positioned thereon, and a side seal positioned on the first overlay piece and the second overlay piece.

The present application further provides a sealing assembly for use with a transition piece and a stage one nozzle of a gas turbine engine. The sealing assembly may include a first seal element with a first C-seal and a first overlay piece at first seal element corner thereof, a second seal element with a second C-seal and a second overlay piece at second seal element corner thereof and a side seal positioned on the first overlay piece and the second overlay piece. The first seal element and the second seal element may define a gap therebetween.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a known gas turbine engine.

FIG. 2 is a perspective view of portions of a known transition piece sealing assembly.

FIG. 3 is a side view of portions of the known transition piece sealing assembly of FIG. 2.

FIG. 4 is a perspective view of a seal with an overlay piece as may be described herein.

FIG. 5 is a perspective view of a number of seals with overlay pieces and a side seal of a transition piece sealing assembly as may be described herein.

### DETAILED DESCRIPTION

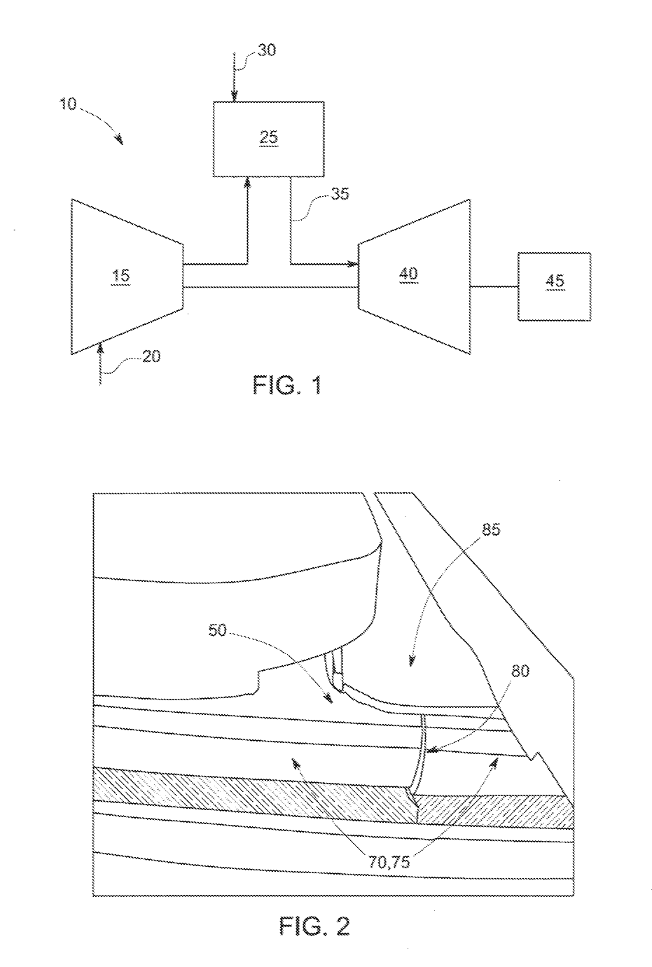

Referring now to the drawings, in which like numerals refer to like elements throughout the several views, FIG. 1 shows a schematic view of a gas turbine engine 10 as may be described herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is delivered in turn to a turbine 40. The flow of combustion gases 35 drives the turbine 40 so as to produce mechanical work. The mechanical work produced in the turbine 40 drives the compressor 15 and an external load 45 such as an electrical generator and the like.

The gas turbine engine 10 may use natural gas, various types of syngas, and/or other types of fuels. The gas turbine engine 10 may be one of any number of different gas turbine engines offered by General Electric Company of Schenectady, N.Y. such as a heavy duty 7FA gas turbine engine and the like. The gas turbine engine 10 may have other configurations and may use other types of components. Other types of gas turbine engines also may be used herein. Multiple gas turbine engines 10, other types of turbines, and other types of power generation equipment also may be used herein together.

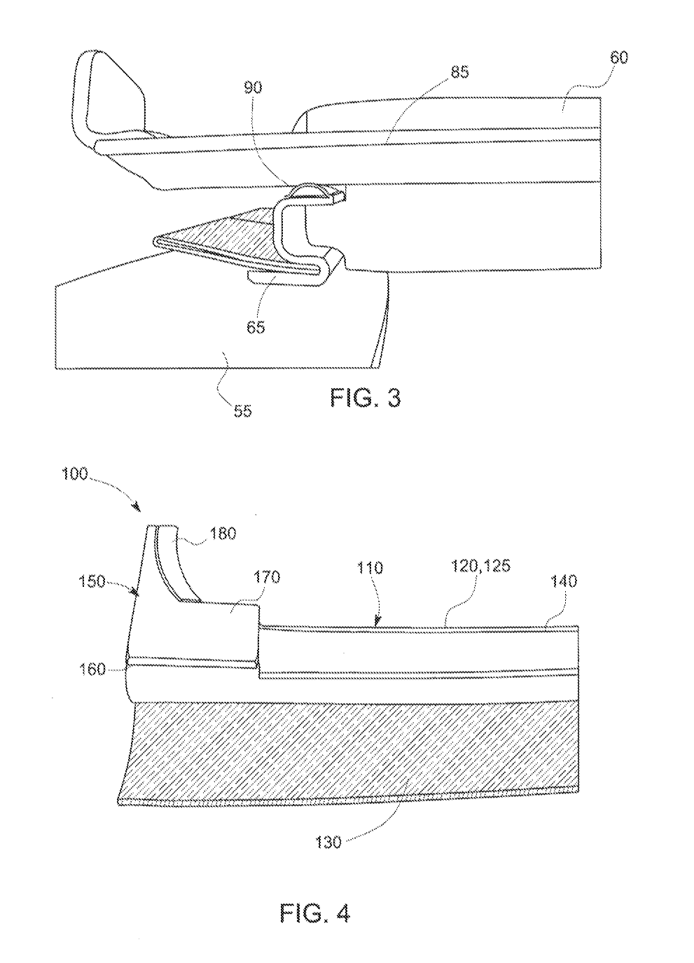

FIGS. 2 and 3 show portions of a known transition piece sealing assembly 50. As described above, the transition piece sealing assembly 50 may be positioned between a transition piece 55 and a stage one nozzle 60. As is shown in FIG. 2, the transition piece seal assembly 50 may include a number of seals 65, in this case, a first or an inner seal 70 and a second or an outer seal 75. A gap 80 may be positioned between the fist seal 70 and the second seal 75. A side seal 85 may be positioned about the first seal 70 and the second seal 75 about the gap 80. A C-seal 90 may be positioned between the seals 70, 75, and the side seal 85. Other configurations of transition piece sealing assemblies may be known.

As described above, leakage air may flow through the gap 80 if the side seal 85 does not sit properly on the first seal 70 and the second seal 75. The use of the C-seal 90 only provides line contact with the side seal 85 and thus may be of limited effectiveness in limited the leakage flow therethrough.

FIG. 4 shows a portion of a transition piece sealing assembly 100 as may be described herein. The transition piece sealing assembly 100 may include a number of seal elements 110. The seal elements 110 may include a first or an inner seal 120, a second or an outer seal 125, and/or other types of seals. In this example, the seal elements 110 may include a cloth seal 130 and a C-seal 140. Other configurations may be used herein.

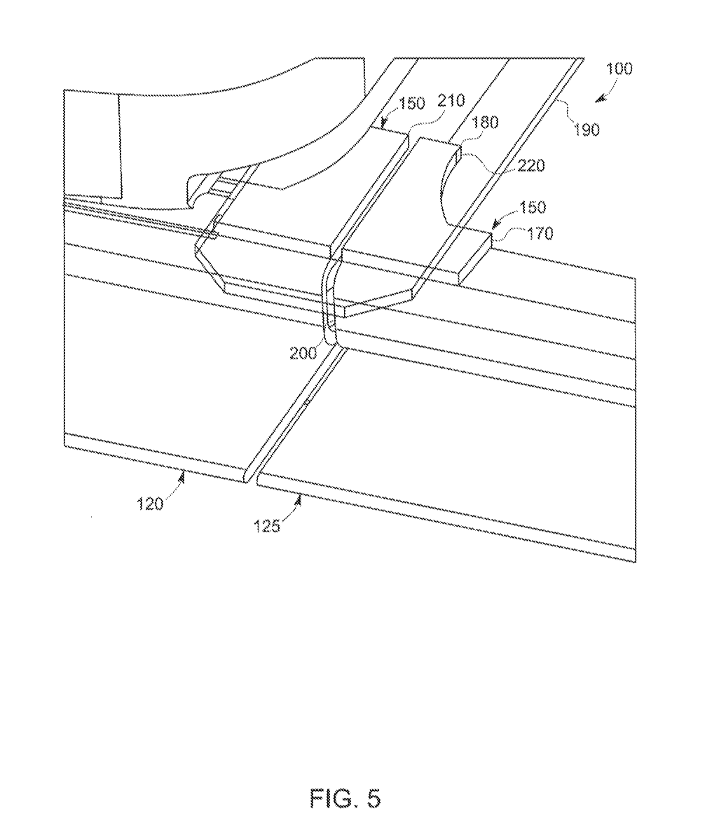

The C-seal 140 of the sealing element 110 may not extend the entire length thereof. Rather, an overlay piece 150 may be positioned at an end or a corner 160 thereof. The overlay piece 150 may include a mounting area 170 for attaching to the seal element 110 and an extended wing or flange 180 that extends in the direction of the length of a side seal 190 (of FIG. 5). The overlay piece 150 may be welded, brazed, or otherwise attached to the seal element 110. The overlay piece 150 also may be integral with the seal element 110 or the side seal 190.

Each overlay piece 150 may be about half the width of the side seal 190 so as to allow the side seal 190 to sit thereon when the first seal 120 and the second seal 125 are positioned together. The overlay piece 150 may have about the height as the C-seal 140 so as to provide sealing along the length of the sealing element 110. The overlay piece 150 and the elements thereof may have other sizes, shapes, and configurations. Specifically, the overlay piece 150 may be sized and shaped for a particular configuration of the side seal 190 and the like. The overlay piece 150 may be made out of any type of heat resistant materials.

FIG. 5 shows the first seal 120 and the second seal 125 with the side seal 190 thereon of the transition piece sealing assembly 100. The first seal 120 and the second seal 125 may define a gap 200 therebetween as described above. As can be seen, each sealing element 110 has an overlay piece 150 at the corner 160 thereof, a first overlay piece 210 and a second overlay piece 220. The extended wings or flanges 180 of each overlay piece 150 thus align with the side seal 190. Specifically, the overlay pieces 150 provide a flat surface on which the side seal 190 can sit so as to reduce air leakage through the gap 200. The overlay pieces 150 ensure such low leakage by providing area contact with the side seal 190 as opposed to the line contact found in the use of, for example, only the C-seals 140 described above. One of the overlay pieces 150 also may extend into the gap 200 and overlap the adjacent overlay piece 150 to limit further the leakage therethrough. Other configurations also may be used herein.

The use of the overlay pieces 150 in the transition piece sealing assembly 100 thus may improve emissions and overall system efficiency. The overlay pieces 150 achieve these goals by limiting the leakage rate through the gap 200 by properly sitting the side seal 190 thereon.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A sealing assembly for use with a transition piece and a stage one nozzle of a gas turbine engine, comprising:
a seal element;
an overlay piece positioned on the seal element; and
a side seal positioned on the overlay piece.

2. The sealing assembly of claim 1, further comprising a plurality of seal elements.

3. The sealing assembly of claim 2, wherein the plurality of seal elements comprises a first seal element and a second seal element.

4. The sealing assembly of claim 3, further comprising a gap between the first seal element and the second seal element.

5. The sealing assembly of claim 1, further comprising a plurality of overlay pieces.

6. The sealing assembly of claim 5, wherein the plurality of overlay pieces comprises a first overlay piece and a second overlay piece.

7. The sealing assembly of claim 6, wherein the first overlay piece overlaps the second overlay piece.

8. The sealing assembly of claim 1, wherein the overlay piece comprises a mounting area for attaching to the seal element and an extended flange.

9. The sealing assembly of claim 1, further comprising a C-seal positioned about the overlay piece.

10. The sealing assembly of claim 1, wherein the seal element comprises a cloth seal thereon.

11. A sealing assembly for use with a transition piece and a stage one nozzle of a gas turbine engine, comprising:
a first seal element;
a first overlay piece positioned on the first seal element;
a second seal element;
a second overlay piece positioned on the second seal element; and
a side seal positioned on the first overlay piece and the second overlay piece.

12. The sealing assembly of claim 11, further comprising a gap between the first seal element and the second seal element.

13. The sealing assembly of claim 11, wherein the first overlay piece overlaps the second overlay piece.

14. The sealing assembly of claim 11, wherein the first and the second overlay pieces both comprise a mounting area for attaching to respective seal elements and an extended flange.

15. The sealing assembly of claim 11, wherein the first and the second sealing elements both comprise a C-seal positioned about the respective overlay piece.

16. The sealing assembly of claim 11, wherein the first and the second sealing elements both comprise a cloth seal thereon.

17. A sealing assembly for use with a transition piece and a stage one nozzle of a gas turbine engine, comprising:
a first seal element;
the first seal element comprising a first C-seal and a first overlay piece at first seal element corner thereof;
a second seal element;
the second seal element comprising a second C-seal and a second overlay piece at second seal element corner thereof;
the first seal element and the second seal element defining a gap therebetween; and
a side seal positioned on the first overlay piece and the second overlay piece about the gap.

18. The sealing assembly of claim 17, wherein the first overlay piece overlaps the second overlay piece.

19. The sealing assembly of claim 17, wherein the first and the second overlay pieces both comprise a mounting area for attaching to respective seal elements and an extended flange.

20. The sealing assembly of claim 17, wherein the first and the second sealing elements both comprise a cloth seal thereon.
